(19) United States
(12) Patent Application Publication
(10) Pub. No.: US 2022/0012816 A1
(43) Pub. Date: Jan. 13, 2022

(54) INFORMATION PROCESSING APPARATUS AND PROGRAM

(71) Applicant: TOSHIBA TEC KABUSHIKI KAISHA, Tokyo (JP)

(72) Inventor: Naoko SATO, Kawasaki Kanagawa (JP)

(21) Appl. No.: 17/320,142

(22) Filed: May 13, 2021

(30) Foreign Application Priority Data
Jul. 9, 2020 (JP) 2020-118748

(51) Int. Cl. G06Q 40/00; G06Q 20/20; G06F 16/53

(52) U.S. Cl. CPC G06Q 40/12; G06Q 20/209; G06Q 20/208; G06Q 20/202; G06F 16/53

(57) ABSTRACT

According to an embodiment, an information processing apparatus includes a first acquiring unit, a second acquiring unit, a receiving unit, and a display unit. The first acquiring unit acquires totalization information for each of a plurality of items. The totalization information is generated based on an adjustment receipt. The adjustment receipt has sales data in a predetermined period in a tenant printed thereon. The second acquiring unit acquires receipt image data of the sales data on the adjustment receipt. The receiving unit receives item information of the totalization information. The display unit makes the acquired totalization information and the sales data of the acquired receipt image data for the received item information to be displayed at a position corresponding to the sales data relating to the totalization information.

### CROSS-REFERENCE TO RELATED APPLICATION

This application is based upon and claims the benefit of priority from Japanese Patent Application No. 2020-118748, filed Jul. 9, 2020, the entire contents of which are incorporated herein by reference.

### FIELD

Embodiments described herein relate generally to an information processing apparatus and an information processing program.

### BACKGROUND

In a retail environment such as a shopping center (SC) where a large number of tenants have their own shops or stalls sales by each of the respective tenants might be totaled once a day, for example. Each tenant prints out, using a Point of Sales (POS) terminal, an adjustment receipt on which sales data for the day are totaled and listed for each of the items sold during the day. Each tenant creates totalization information or aggregated information obtained by manually inputting the sales data (for example, daily account data obtained by totaling the sales in the day) into an input terminal according to the printed adjustment receipt. The totalization information is then transmitted to a server from each of the respective tenants. Typically, the printed adjustment receipts are then sent to the headquarters of the Sc. The SC can then compare the electronically transmitted totalization information with the printed adjustment receipts and closely inspects the sales data for discrepancies.

Since such close inspection work takes labor and time, recently, shopping center entities have begun to create receipt image information by digitizing the adjustment receipts and this digitized receipt image information is compared to the electronically transmitted totalization information, for example, on a screen of a system installed at the SC headquarters or the like for purposes of closely inspect the sales data.

However, since there are often many items to be checked, the close inspection of the sales data still takes labor and time.

### BRIEF DESCRIPTION OF THE DRAWINGS

FIG. 1 depicts an example system in a shopping center according to an embodiment.

FIG. 2 is a block diagram illustrating an example configuration of a POS terminal according to an embodiment.

FIG. 3 is a block diagram illustrating an example configuration of an input terminal according to an embodiment.

FIG. 4 is a block diagram illustrating an example configuration of a server according to an embodiment.

FIG. 5 depicts example receipt image data according to an embodiment.

FIG. 6 is a block diagram illustrating an example configuration of a browsing terminal according to an embodiment.

FIG. 7 is a flowchart of control processing for a POS terminal according to an embodiment.

FIG. 8 is a flowchart of control processing for an input terminal according to an embodiment.

FIG. 9 is a block diagram illustrating an example configuration of a server according to an embodiment.

FIG. 10 is a flowchart of control processing for a server according to an embodiment.

FIG. 11 is a flowchart of control processing for a browsing terminal according to an embodiment.

FIG. 12 depicts an example display screen of a browsing terminal according to an embodiment.

FIG. 13 depicts an example display screen of a browsing terminal according to an embodiment.

FIG. 14 depicts an example display screen of a browsing terminal according to an embodiment.

### DETAILED DESCRIPTION

At least one embodiment of the present disclosure provides an information processing apparatus and an information processing program permitting close inspecting sales data from a shopping center retail environment with less labor and time.

In general, according to one embodiment, an information processing apparatus includes a first acquiring unit configured to acquire totalization information from a tenant terminal. The totalization information reflects sales data from an adjustment receipt for a tenant during a predetermined period. A second acquiring unit is configured to acquire receipt image data including the sales data from the adjustment receipt. A display unit is configured to simultaneously display the totalization information acquired by the first acquiring unit and the receipt image data acquired by the second acquiring unit. A receiving unit is configured to receive a request for an item information in the totalization information. The display unit displays the sales data from the receipt image data for the requested item information in a position corresponding to the sales data relating to the requested item information of the totalization information.

Certain example embodiments will be described with reference to the accompanying drawings. In the example embodiments, a server is utilized as one possible example of an information processing apparatus. The present disclosure is not limited to these particular example embodiments.

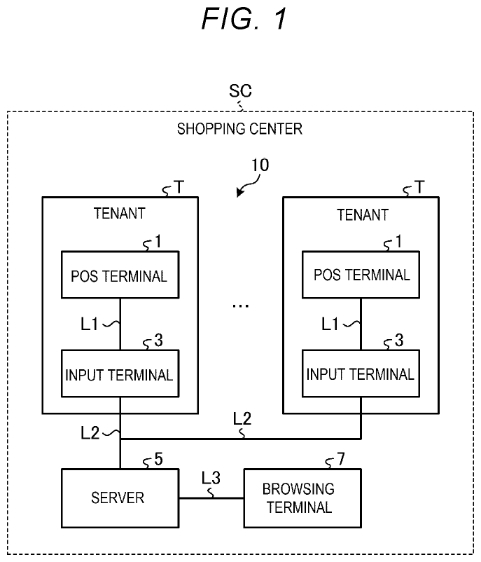

FIG. 1 is a diagram illustrating a system 10 according to one embodiment. The system 10 is installed in a shopping center SC and includes POS terminals 1, input terminals 3, a server 5, and a browsing terminal 7.

As illustrated in FIG. 1, a plurality of tenants T have individual shops in the shopping center SC. For each of the tenants T, at least one POS terminal 1 and an input terminal 3 are installed. The POS terminal(s) 1 and the input terminal 3 of the tenant T are connected to each other by a communication line L1. The POS terminal 1 and the input terminal 3 may be integrated as a tenant terminal in some examples.

The server 5 and the browsing terminal 7 are installed in a back office of the shopping center SC. The input terminals 3 of the tenants T are connected to the server 5 by a communication line L2 such as a Local Area Network (LAN). The server 5 and the browsing terminal 7 are connected to each other by a communication line L3.

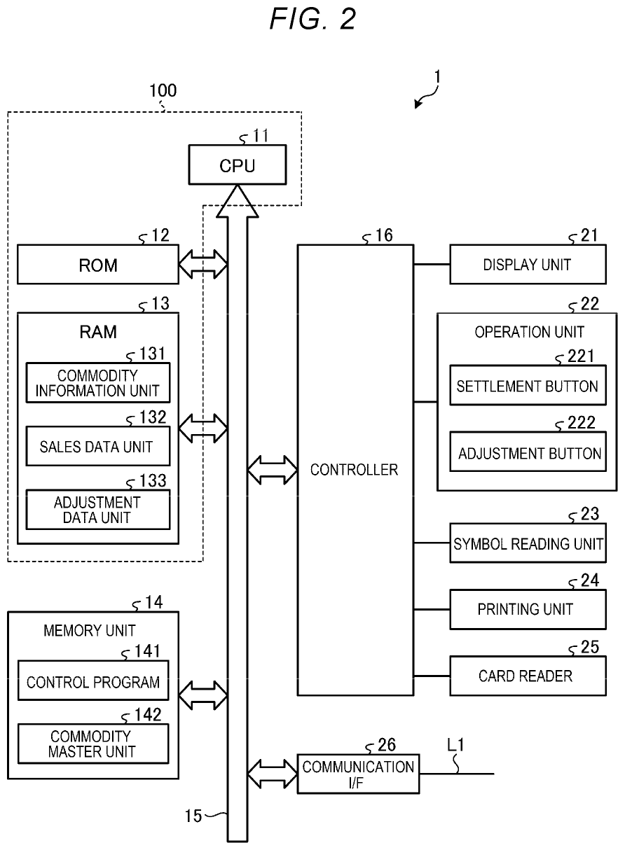

The POS terminal 1 performs commodity data processing and settlement processing for commodities being purchased by a customer at a tenant T (also referred to as tenant shop T in some instances). The POS terminal 1 captures an image of a symbol such as a barcode attached to a commodity to be sold and acquires a commodity code for identifying the commodity corresponding to the symbol. The commodity data processing includes processing in which the POS terminal 1 displays commodity information (including a commodity name, a price, and the like) of the commodity that has been read out based on the acquired commodity code and stores the commodity information in a RAM 13 (see FIG. 2) or the like. In some examples, the POS terminal 1 may optically read the image of the symbol attached to the commodity and acquire the commodity code corresponding to the symbol. The settlement processing executed by the POS terminal 1 includes processing for displaying a total amount relating to a relevant transaction based on the commodity information stored in the RAM 13 or the like by the commodity data processing, processing for calculating and displaying change due based on a deposit (payment) from the customer, and proces ing for instructing a change machine to pay the change due. The settlement processing includes processing for issuing a receipt on which the commodity information and settlement information (including a total amount, a deposit amount, a change amount, and the like) in the sales transaction is printed.

Once a predetermined period (for example, each day), the POS terminal 1 issues an adjustment receipt on which sales data reflecting all of commodities sold by the tenant T during the predetermined period. The adjustment receipt is a report on which the sold item information including prices and number of sold items (herein collectively referred to as “sales data”) for the predetermined period are collected and categorized by transaction type (for example, cash sales, coupon sales, and credit sales). For example, cash sales in the predetermined period is printed as the sales data in association with the item category “cash sales” on the adjustment receipt. The number of coupons (or vouchers) used in the predetermined period and amount data for coupon sales in the predetermined period is printed as the sales data in association with the item category “coupon sales” on the adjustment receipt. The number of cases of settlement processing by credit cards in the predetermined period and amount data for credit card sales in the predetermined period is printed as the sales data in association with the item category “credit sales” on the adjustment receipt. The sales data for the items is printed in positions corresponding to the items on the adjustment receipt.

Upon issuance of the adjustment receipt, the POS terminal 1 stores printing data used for the printing of the adjustment receipt (herein referred to as “adjustment data”). The POS terminal 1 transmits the stored adjustment data to the input terminal 3.

The input terminal 3 receives the adjustment data from in the POS terminal 1. The input terminal 3 accesses the POS terminal 1 at a predetermined timing (for example, once at predetermined time each day) and monitors whether the adjustment data has been created in the POS terminal 1. If the adjustment data is created in the POS terminal 1, the input terminal 3 receives the adjustment data from the POS terminal 1. The input terminal 3 generates receipt image data based on the received adjustment data. The receipt image data can be, for example, text data or may be unstructured data obtained by imaging or optical character recognition of a printed adjustment receipt printed out by the POS terminal 1.

The input terminal 3 generates daily account data based on the adjustment receipt printed out by the POS terminal 1. A person in charge of the tenant T (e.g., a store manager) operates a keyboard provided in the input terminal 3 and manually inputs sales data of the items while viewing the adjustment receipt as printed by the POS terminal 1. At the input terminal 3, the items printed on the adjustment receipt are displayed, for example, in printing order every time a predetermined key is pressed. The person in charge operates the keyboard and inputs, with respect to the displayed items, the sales data printed on the adjustment receipt corresponding to the items. The input terminal 3 generates the daily account data based on the input sales data. The daily account data is an example of totalization information (or aggregated information) and is, for example, information obtained by collecting sales data for one day for each of the items.

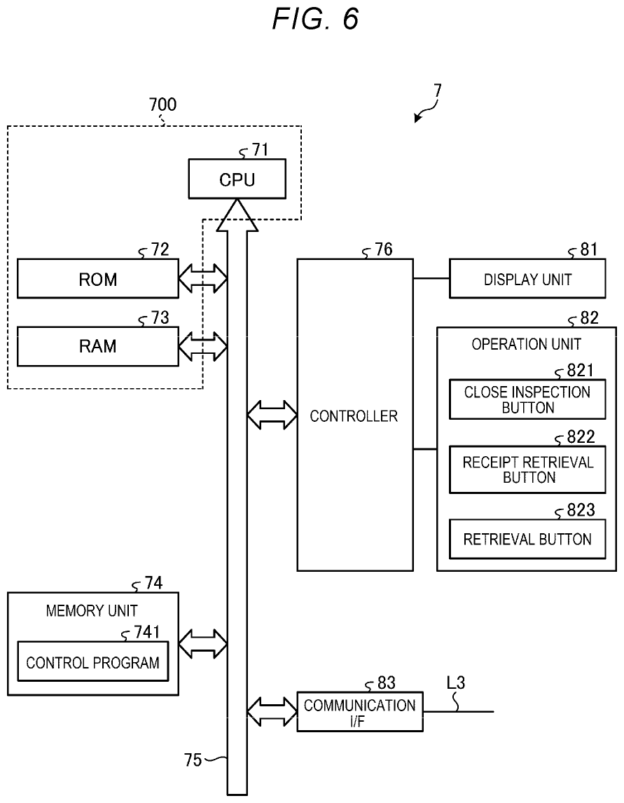

The server 5 is a computer that manages the sales data from the tenants T. The server 5 receives the daily account data and the receipt image data transmitted by the input terminals 3 of the tenants T and stores them for each of the tenants T. The server 5 transmits the daily account data and the receipt image data for each of the tenants T to the browsing terminal 7 in response to a browsing request from the browsing terminal 7. For example, upon receipt of the browsing request including information regarding a specific item from the browsing terminal 7, the server 5 transmits the daily account data and the receipt image data to the browsing terminal 7 to cause the browsing terminal 7 to display, with respect to the receipt image data, both the requested item and its sales data on the same screen of a display unit 81 (see FIG. 6) while associating the requested item and its sales data with the same item as the requested item in the daily account data. In one example, both the requested item relating to the receipt image data and the sales data relating to the requested item are arranged in the same row as the same item in the daily account data.

The browsing terminal 7 is an apparatus that displays information received from the server 5 and permits such information to be viewed (browsed) by a user. The browsing terminal 7 functions as a browser for browsing information, data, and the like. The browsing terminal 7 displays the daily account data and the receipt image data received from the server 5 side by side on the same screen of the display unit 81. To closely inspect sales of a tenant T, the user operates the browsing terminal 7 and requests the specific daily account data and receipt image data for the relevant tenant T. Upon receipt of the request, the server 5 transmits the daily account data and receipt image data of the tenant T to the browsing terminal 7. The browsing terminal 7 displays the received daily account data and the received receipt image data simultaneously side by side on the same screen. If the user enters an item that he or she desires to closely inspect at the browsing terminal 7, the server 5 transmits, to the browsing terminal 7, data for displaying both the requested item relating to the receipt image data and the sales data relating to the requested item side by side in the same display row. The browsing terminal 7 displays, based on the received daily account data and the received receipt image data, the item and the sales data relating to the item in the same row of the daily account data and the receipt image data.

FIG. 2 is a block diagram illustrating an example configuration of the POS terminal 1 according to the present embodiment. As illustrated in FIG. 2, the POS terminal 1 includes a control unit 100 and a memory unit 14. The control unit 100 includes a Central Processing Unit (CPU) 11, a Read-Only Memory (ROM) 12, and a Random-Access Memory (RAM) 13. The ROM 12 stores various programs. Programs and various data are loaded in the RAM 13. The memory unit 14 stores various programs. The CPU 11, the ROM 12, the RAM 13, and the memory unit 14 are connected to one another via a bus 15. The CPU 11 operates according to a control program stored in the ROM 12 and/or the memory unit 14 and then loaded in the RAM 13, whereby the control unit 100 executes control processing relating to the POS terminal 1.

The RAM 13 includes a commodity information unit 131, a sales data unit 132, and an adjustment data unit 133. The commodity information unit 131 stores commodity information (including a price of a commodity, a commodity name, and the like) of a commodity subjected to commodity data processing. The sales data unit 132 performs an adjustment process and stores sales data in the POS terminal 1 in a predetermined period (for example, one day). In the case of one POS terminal 1 per one tenant T, the sales data unit 132 stores the sales data for each day of each tenant T. Upon print and issuance of an adjustment receipt based on the sales data stored in the sales data unit 132, the adjustment data unit 133 stores the adjustment data relating to the adjustment receipt.

The memory unit 14 is, for example, a nonvolatile memory such as a Hard Disk Drive (HDD) or a flash memory in which stored information is retained even if a power supply is turned off. The memory unit 14 stores a control program 141 and a commodity master 142. The control program 141 provides a software program for controlling the POS terminal 1. The commodity master 142 stores commodity information for each commodity code for identifying a commodity.

The control unit 100 is connected to a display unit 21, an operation unit 22, a symbol reading unit 23, a printing unit 24, and a card reader 25 via the bus 15 and a controller 16. The display unit 21 includes both a display that displays information to an operator, a person in charge, or the like and a display that displays information to a customer. The operation unit 22 includes a keyboard that has a settlement button 221 and an adjustment button 222. The operation unit 22 may include a touch key provided on the display unit 21. The settlement button 221 is operated by the operator to finish the commodity data processing for the customer and shift to the settlement processing. The adjustment button 222 is operated by the operator to start the adjustment process by the POS terminal 1. The symbol reading unit 23 includes a scanner or a reader that images or optically reads a symbol such as a barcode or a two-dimensional code attached to a commodity.

When the settlement button 221 is operated, the printing unit 24 prints the commodity information stored in the commodity information unit 131 and the settlement information subjected to the settlement processing and issues both the commodity information and the settlement information as a receipt. When the adjustment button 222 is operated, the printing unit 24 reads out and prints the sales data in the predetermined period stored in the sales data unit 132 and issues the sales data as an adjustment receipt. The card reader 25 reads card information of a credit card or the like in the settlement processing.

The control unit 100 is connected to a communication unit 26, which includes a communication interface (I/F), via the bus 15. The communication unit 26 is connected to the input terminal 3 via the communication line L1 and transmits information to the input terminal 3.

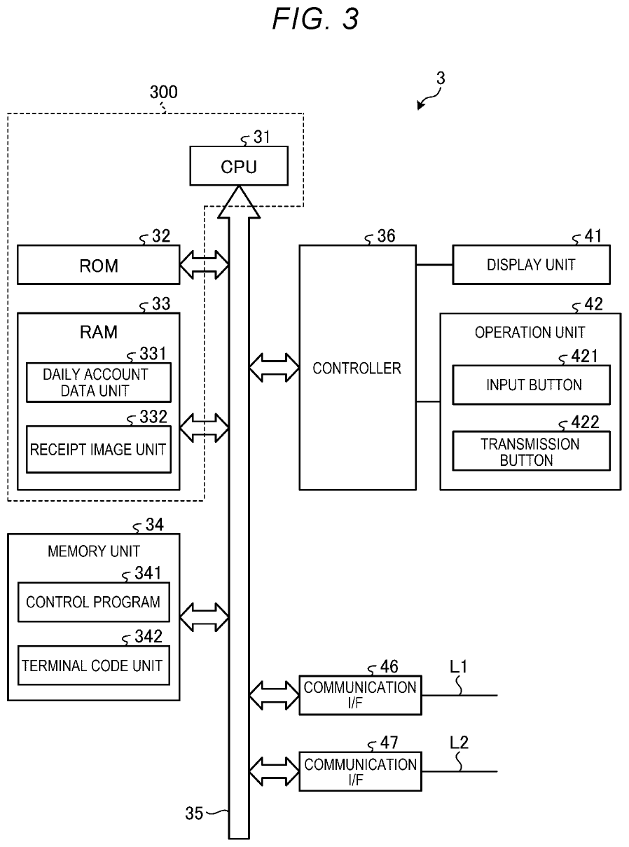

FIG. 3 is a block diagram illustrating an example configuration of the input terminal 3 according to the present embodiment. As illustrated in FIG. 3, the input terminal 3 includes a control unit 300 and a memory unit 34. The control unit 300 includes a CPU 31, a ROM 32, and a RAM 33. The ROM 32 stores various programs. Programs and various data are loaded in the RAM 33. The memory unit 34 stores various programs. The CPU 31, the ROM 32, the RAM 33, and the memory unit 34 are connected to one another via a bus 35. The CPU 31 operates according to a control program stored in the ROM 32 and the memory unit 34 and loaded in the RAM 33, whereby the control unit 300 executes control processing for the input terminal 3.

The RAM 33 includes a daily account data unit 331 and a receipt image unit 332. The person in charge inputs sales data for each of items while viewing the adjustment receipt printed and issued by the POS terminal 1. The daily account data unit 331 stores the input sales data for each of the items as daily account data. The receipt image unit 332 stores receipt image data generated based on the adjustment data received from the POS terminal 1.

The memory unit 34 is an HDD, a flash memory, or the like and maintains stored content even if a power supply is turned off. The memory unit 34 stores a control program 341 and a terminal code unit 342. The control program 341 provides a software program for controlling the input terminal 3. The terminal code unit 342 stores a tenant code for identifying the tenant T at which the input terminal 3 is installed.

The control unit 300 is connected to a display unit 41 and an operation unit 42 via the bus 35 and a controller 36. The display unit 41 displays information to an operator who operates the input terminal 3. The operation unit 42 can be a keyboard for operating the input terminal 3 including an input button 421 and a transmission button 422. The input button 421 is used to manually input sales data for each of items. The transmission button 422 is operated to transmit the daily account data stored in the daily account data unit 331 and the receipt image data stored in the receipt image unit 332 to the server 5.

The control unit 300 is connected to a communication unit 46, which includes a communication interface (I/F), and a communication unit 47, which includes a communication interface (I/F), via the bus 35. The communication unit 46 performs transmission and reception of information to and from the POS terminal 1 via the communication line L1. The communication unit 47 performs transmission and reception of information to and from the server 5 via the communication line L2.

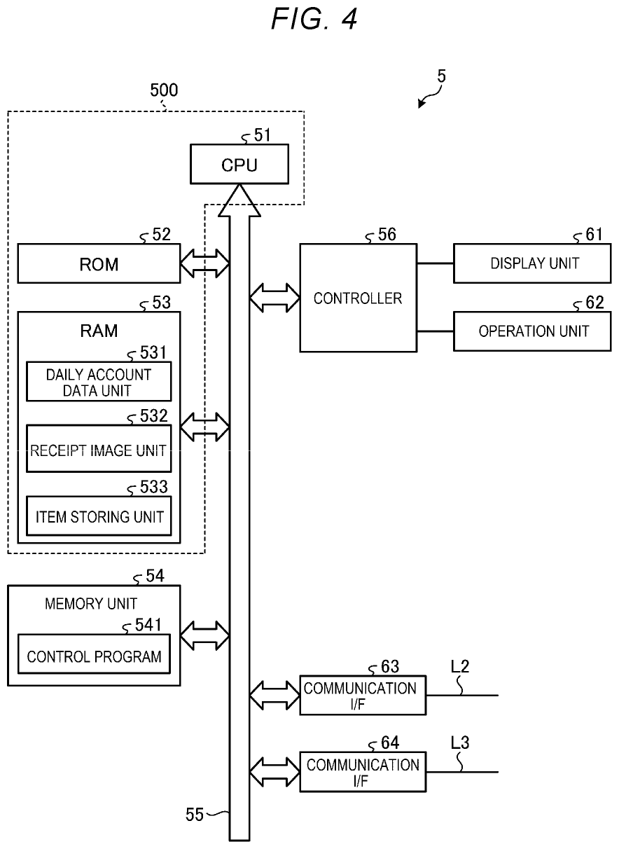

FIG. 4 is a block diagram illustrating an example configuration of the server 5 according to the present embodiment. As illustrated in FIG. 4, the server 5 includes a control unit 500 and a memory unit 54. The control unit 500 includes a CPU 51, a ROM 52, and a RAM 53. The ROM 52 stores various programs. Programs and various data are loaded in the RAM 53. The memory unit 54 stores various programs. The CPU 51, the ROM 52, the RAM 53, and the memory unit 54 are connected to one another via a bus 55. The CPU 51 operates according to a control program stored in the ROM 52 and the memory unit 54 and loaded in the RAM 53, whereby the control unit 500 executes control processing for the server 5.

The RAM 53 includes a daily account data unit 531, a receipt image unit 532, and an item storing unit 533. The daily account data unit 531 stores daily account data received from the input terminal 3. The receipt image unit 532 stores receipt image data received from the input terminal 3. The item storing unit 533 stores item information of a retrieval-requested item received from the browsing terminal 7.

The memory unit 54 is an HDD, a flash memory, or the like and maintains stored content even if a power supply is turned off. The memory unit 54 stores a control program 541. The control program 541 provides a software program for controlling the server 5.

The control unit 500 is connected to a display unit 61 and an operation unit 62 via the bus 55 and a controller 56. The display unit 61 displays information to an operator who operates the server 5. The operation unit 62 is a keyboard for operating the server 5.

The control unit 500 is connected to a communication unit 63, which includes a communication interface (I/F), and a communication unit 64, which includes a communication interface (I/F) via the bus 55. The communication unit 63 performs transmission and reception of information to and from the input terminal 3 via the communication line L2. The communication unit 64 performs transmission and reception of information to and from the browsing terminal 7 via the communication line L3.

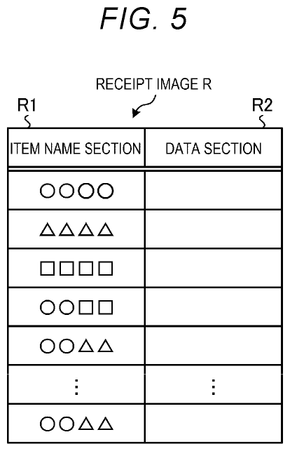

The receipt image data is unstructured data (for example, text data) obtained by imaging the printed data of an adjustment receipt by the POS terminal 1 and a plurality of items and sales data for each of the items. FIG. 5 is an explanatory diagram illustrating an example configuration of receipt image data R according to the present embodiment. As illustrated in FIG. 5, the receipt image data R includes an item name section R1 and a data section R2. The item name section R1 stores item information indicating items (such as cash sales, coupon sales, and credit sales). The data section R2 stores sales data relating to the item information stored in the item name section R1. That is, the receipt image data R stores the sales data for each of a plurality of items. For example, a sales amount in cash in a predetermined period is stored in the data section R2 in association with the item of the cash sales stored in the item name section R1. The number of used coupons and a sales amount by the coupons in the predetermined period are stored in the data section R2 in association with the item of the coupon sales stored in the item name section R1. The number of times credit cards are used and a sales amount by the credit cards in the predetermined period are stored in the data section R2 in association with the item of the credit sales stored in the item name section R1. Accordingly, if an item is designated, sales data relating to the designated item is identified. By searching an item, sales data relating to the searched item is retrieved.

FIG. 6 is a block diagram illustrating an example configuration of the browsing terminal 7 according to the present embodiment. As illustrated in FIG. 6, the browsing terminal 7 includes a control unit 500 and a memory unit 54. The control unit 500 includes a CPU 71, a ROM 72, and a RAM 73. The ROM 72 stores various programs. Programs and various data are loaded in the RAM 73. The memory unit 74 stores various programs. The CPU 71, the ROM 72, the RAM 73, and the memory unit 74 are connected to one another via a bus 75. The CPU 71 operates according to a control program stored in the ROM 72 and the memory unit 74 and loaded in the RAM 73, whereby the control unit 700 executes control processing for the browsing terminal 7.

The memory unit 74 is an HDD, a flash memory, or the like and maintains stored content even if a power supply is turned off. The memory unit 74 stores a control program 741. The control program 741 provides a software program for controlling the browsing terminal 7.

The control unit 700 is connected to a display unit 81 and an operation unit 82 via the bus 75 and a controller 76. The display unit 81 displays information to an operator who operates the browsing terminal 7. The operation unit 82 is a keyboard for operating the browsing terminal 7, the keyboard including a close inspection button 821, a receipt retrieval button (or a receipt search button) 822, and a retrieval button (or a search button) 823. The close inspection button 821 is operated to start close inspection of daily account data and receipt image data in the tenant T. The receipt retrieval button 822 is operated to start close inspection of daily account data and receipt image data with respect to a specific item. The retrieval button 823 is operated to transmit item information of an input item to be closely inspected to the server 5.

The control unit 700 is connected to a communication unit 83, which includes a communication interface (I/F), via the bus 75. The communication unit 83 performs transmission and reception of information to and from the server 5 via the communication line L3.

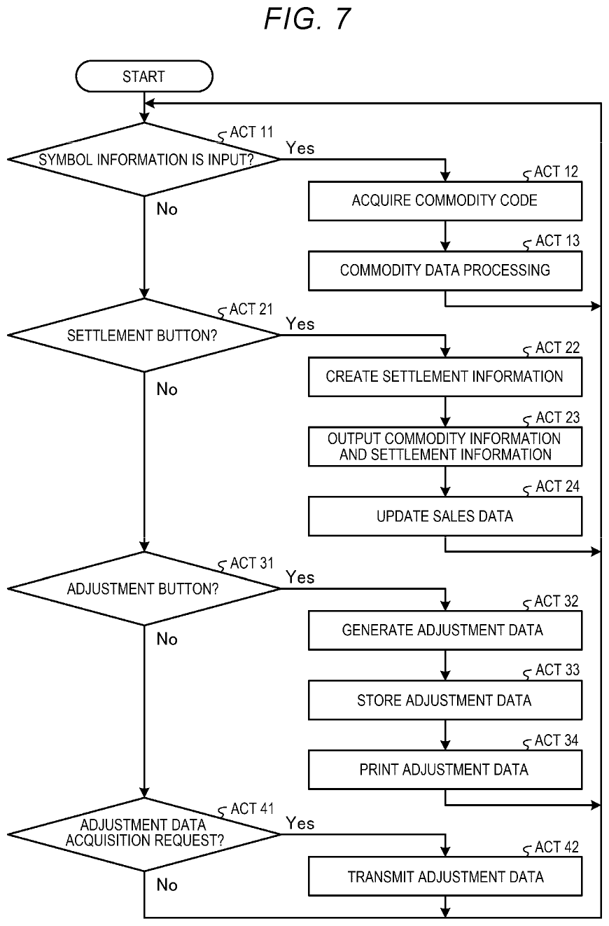

FIG. 7 is a flowchart of control proces sing for the POS terminal 1 according to the present embodiment.

The control unit 100 of the POS terminal 1 determines whether a symbol attached to a commodity read by the symbol reading unit 23 has been input (ACT 11). If the symbol has been input (Yes in ACT 11), the control unit 100 analyzes the input symbol and acquires a commodity code that identifies the commodity (ACT 12). The control unit 100 executes commodity data processing for reading out commodity information (including a commodity name, a price, and the like) relating to the identifiedcommodity fromthe commodity master 142 based on the acquired commodity code and storing the read-out commodity information in the commodity information unit 131 (ACT 13). The control unit 100 returns to ACT 11.

If the symbol has not been input (No in ACT 11), the control unit 100 further determines whether the settlement button 221 has been operated (ACT 21). If the settlement button 221 has been operated (Yes in ACT 21), the control unit 100 executes settlement processing based on the commodity information stored in the commodity information unit 131 (ACT 22). The control unit 100 drives the printing unit 24 and prints and issues a receipt on which the commodity information and settlement information are printed (ACT 23). The control unit 100 updates the sales data stored in the sales data unit 132 by adding present sales data of the customer to the stored sales data based on the commodity information and the settlement information subjected to the settlement processing in ACT 22 (ACT 24). The control unit 100 returns to ACT 11.

If the settlement button 221 has not been operated (No in ACT 21), the control unit 100 further determines whether the adjustment button 222 has been operated (ACT 31). If the adjustment button 222 has been operated (Yes in ACT 31), the control unit 100 generates, based on the sales data stored in the sales data unit 132, adjustment data that indicates sales of the tenant T in a predetermined period and that is printing data for printing an adjustment receipt (ACT 32). Subsequently, the control unit 100 stores the generated adjustment data in the adjustment data unit 133 (ACT 33). The control unit 100 drives the printing unit 24 andprints and issues an adjustment receipt based on the adjustment data stored in the adjustment data unit 133 (ACT 34). The control unit 100 returns to ACT 11. The processing in ACT 32, ACT 33, and ACT 34 is referred to as adjustment processing.

If the adjustment button 222 has not been operated (No in ACT 31), the control unit 100 further determines whether request information relating to acquisition of the adjustment data has been received from the input terminal 3 (ACT 41). If the request information has been received (Yes in ACT 41), the control unit 100 transmits the adjustment data stored in the adjustment data unit 133 to the input terminal 3 (ACT 42). The control unit 100 returns to ACT 11. If the request information has not been received (No in ACT 41), the control unit 100 returns to ACT 11.

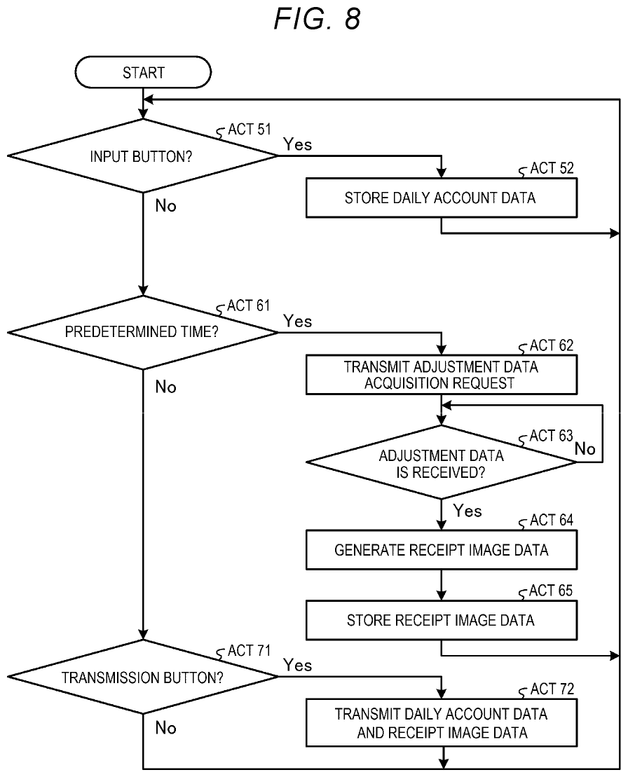

FIG. 8 is a flowchart of control processing for the input terminal 3.

The control unit 300 of the input terminal 3 determines whether the input button 421 has been operated (ACT 51). If the input button 421 has been operated (Yes in ACT 51), the control unit 300 generates, based on sales data input by a person in charge operating the operation unit 42 while viewing the issued adjustment receipt, daily account data including a plurality of items and sales data relating to the items and stores the generated daily account data in the daily-account data unit 331 (ACT 52). The control unit 300 returns to ACT 51.

If the input button 421 has not been operated (No in ACT 51), the control unit 300 further determines whether predetermined time set in advance has come (ACT 61). The predetermined time indicates suitable time for collecting the adjustment data, such as time adjusted to closing time of a store. If the predetermined time has come (Yes in ACT 61), the control unit 300 transmits information indicating an acquisition request for the adjustment data to the POS terminal 1 (ACT 62).

Subsequently, the control unit 300 determines whether the adjustment data has been received from the POS terminal 1 (ACT 63). The control unit 300 stays on standby until the adjustment data is received from the POS terminal 1 (No in ACT 63).

If the adjustment data has been received from the POS terminal 1 (Yes in ACT 63), the control unit 300 generates receipt image data based on the received adjustment data (ACT 64). The control unit 300 stores the generated receipt image data in the receipt image unit 332 (ACT 65). The control unit 300 returns to ACT 51.

If the predetermined time has not come yet (No in ACT 61), the control unit 300 determines further whether the transmission button 422 has been operated (ACT 71).

If the transmission button 422 has been operated (Yes in ACT 71), the control unit 300 transmits both the daily account data stored in the daily account data unit 331 and the receipt image data stored in the receipt image unit 332 to the server 5 together with the tenant code stored in the terminal code unit 342 (ACT 72). The control unit 300 returns to ACT 51. If the transmission button 422 has not been operated (No in ACT 71), the control unit 300 returns to ACT 51.

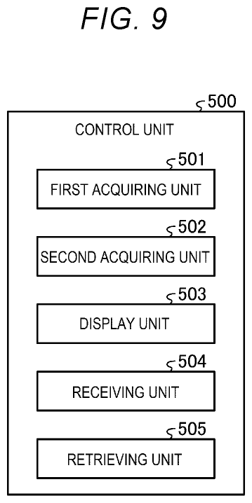

FIG. 9 is a block diagram illustrating an example functional configuration of the server 5 according to the present embodiment. The control unit 500 of the server 5 conforms to the control program stored in the ROM 52 and the memory unit 54 and loaded in the RAM 53 to function as a first acquiring unit 501, a second acquiring unit 502, a display unit 503, a receiving unit 504, and a retrieving unit 505.

The first acquiring unit 501 acquires daily account data for each of items generated based on an adjustment receipt on which sales data in a predetermined period in the tenant T is printed for each of the items. For example, the first acquiring unit 501 acquires, from the input terminal 3, daily account data generated by the input terminal 3 based on the adjustment receipt on which the sales data in the predetermined period in the tenant T is printed.

The second acquiring unit 502 acquires receipt image data obtained by imaging the sales data for each of the items of the adjustment receipt. For example, the second acquiring unit 502 acquires receipt image data obtained by imaging an item of sales data and the sales data relating to the item, the receipt image data being generated based on the adjustment data received from the POS terminal 1 by the input terminal 3.

The display unit 503 simultaneously displays the daily account data acquired by the first acquiring unit 501 and the receipt image data acquired by the second acquiring unit 502. For example, the display unit 503 displays, respectively for each of items, the daily account data acquired by the first acquiring unit 501 and the receipt image data acquired by the second acquiring unit 502 as the same screen arranged side by side on the display unit 81 of the browsing terminal 7.

The receiving unit 504 receives an input of item information of the daily account data. For example, the receiving unit 504 receives an input of item information of the daily account data received from the browsing terminal 7.

The retrieving unit 505 retrieves the receipt image data acquired by the second acquiring unit 502 based on the received item information. For example, the retrieving unit 505 searches and retrieves the item and the sales data relating to the item in the receipt image data based on the received item information.

The display unit 503 displays the sales data of the receipt image data for the received item information at a position corresponding to the sales data relating to the item of the daily account data. In one instance, the display unit 503 displays the sales data of the receipt image data relating to the item searched by the retrieving unit 505 at a predetermined position on a screen, a display window, or the like of the browsing terminal 7 corresponding to the sales data relating to the same item of the daily account data as the searched item. In another instance, the display unit 503 displays an item and sales data of the receipt image data relating to the item searched by the retrieving unit 505 at a position of the display unit 81 corresponding to the same item of the daily account data as the searched item.

The display unit 503 transmits the daily account data and the receipt image data to the browsing terminal 7, from which the browsing request had been received, and causes the browsing terminal 7 to display the daily account data and the receipt image data.

The display unit 503 causes the browsing terminal 7 to display the retrieval button 823 that is used for requesting search and retrieval of item information.

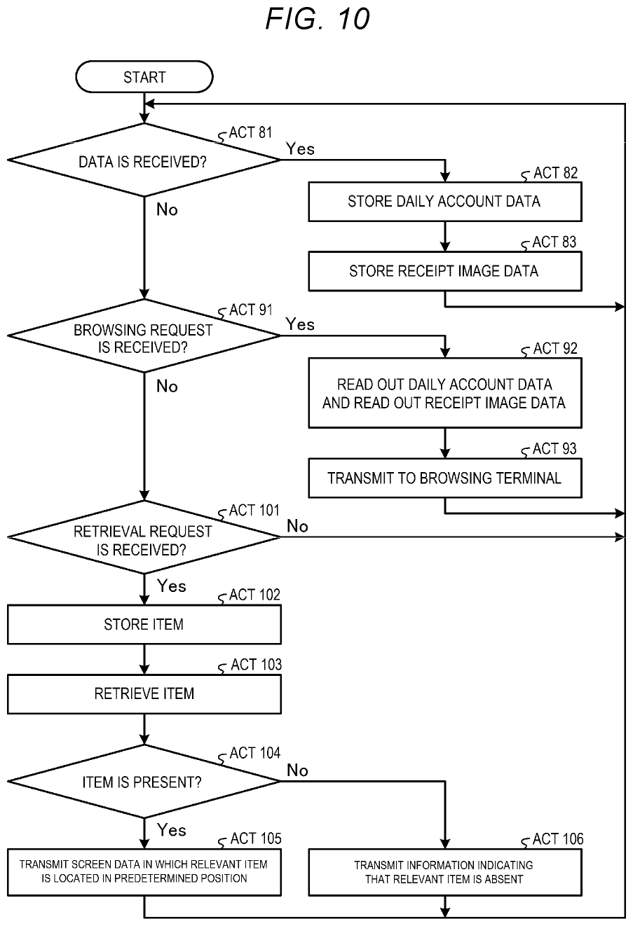

FIG. 10 is a flowchart of control processing for the server 5 according to the present embodiment.

The control unit 500 of the server 5 determines whether daily account data, receipt image data, and a tenant code have been received from the input terminal 3 (ACT 81). If the daily account data and the receipt image data have been received (Yes in ACT 81), the first acquiring unit 501 stores the received daily account data in the daily account data unit 531 for each of the tenant codes to acquire the daily account data (ACT 82). The second acquiring unit 502 stores the received receipt image data in the receipt image unit 532 for each of the tenant codes to acquire the receipt image data (ACT 83). The control unit 500 returns to ACT 81.

If the daily account data and the receipt image data have not been received (No in ACT 81), the control unit 500 further determines whether information concerning a browsing request has been received from the browsing terminal 7 together with a tenant code (ACT 91).

If such information has been received (Yes in ACT 91), the control unit 500 reads out the daily account data relating to the tenant from the daily account data unit 531 (ACT 92). The control unit 500 reads out the receipt image data relating to the tenant from the receipt image unit 532 (ACT 92). The display unit 503 transmits the daily account data and the receipt image data to the browsing terminal 7 to cause the browsing terminal 7 to display the read-out daily account data and the read-out receipt image data side by side on the same screen of the display unit 81 of the browsing terminal 7 (ACT 93). The control unit 500 then returns to ACT 81.

If the information concerning the browsing request has not been received from the browsing terminal 7 (No in ACT 91), the control unit 500 further determines whether an item and information indicating a retrieval request for sales data relating to the item have been received from the browsing terminal 7 (ACT 101).

If such information has been received (Yes in ACT 101), the receiving unit 504 receives the item to be retrieved by storing item information of the received item in the item storing unit 533 (ACT 102).

Subsequently, the retrieving unit 505 searches for the item relating to the item information from the receipt image data stored in the receipt image unit 532 based on the item information stored in the item storing unit 533 (ACT 103). The control unit 500 determines whether the searched item exists in the receipt image data (ACT 104).

If the searched item exists (Yes in ACT 104), the control unit 500 transmits the daily account data and the receipt image data to the browsing terminal 7 such that the item of the receipt image data and sales data relating to the item are displayed in the same row as a row in which the item of the daily account data is described (ACT 105). The control unit 500 returns to ACT 81.

If the searched item does not exist (No in ACT 104), the control unit 500 transmits, to the browsing terminal 7, a message indicating that the item requested for retrieval does not exist (ACT 106). The control unit 500 returns to ACT 81.

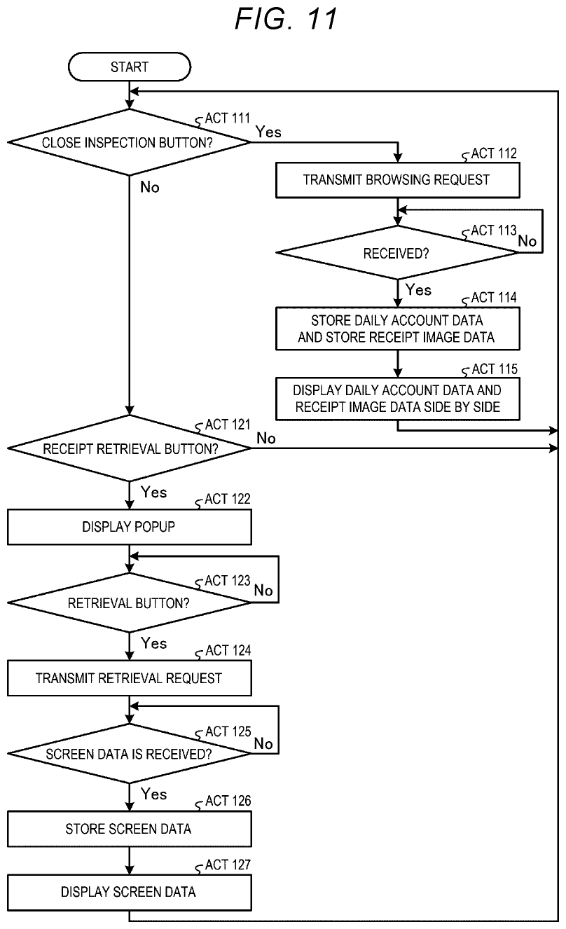

FIG. 11 is a flowchart of control processing relating to close inspection of daily account data and receipt image data in the browsing terminal 7 according to the present embodiment.

A person in charge or an operator of the browsing terminal 7 operates the close inspection button 821 of the browsing terminal 7 and causes the browsing terminal 7 to receive daily account data and the receipt image data from the server 5 and to display the received daily account data and the receipt image data to closely inspect whether the daily account data and the receipt image data coincide with each other.

As illustrated in FIG. 11, the control unit 700 of the browsing terminal 7 first determines whether a tenant code for designating the tenant T has been input and the close inspection button 821 has been operated (ACT 111).

If the tenant code has been input and the close inspection button 821 has been operated (Yes in ACT 111), the control unit 700 transmits a browsing request to the server 5 with the tenant code added to the browsing request (ACT 112). Subsequently, the control unit 700 determines whether the daily account data and the receipt image data have been received from the server 5 (ACT 113). The control unit 700 stays on standby until the daily account data and the receipt image data are received (No in ACT 113).

If the daily account data and the receipt image data have been received (Yes in ACT 113), the control unit 700 stores the received daily account data and the received receipt image data in the RAM 73 (ACT 114). The control unit 700 displays the stored daily account data and the stored receipt image data on the display unit 81 side by side at a time (ACT 115). The control unit 700 returns to ACT 81.

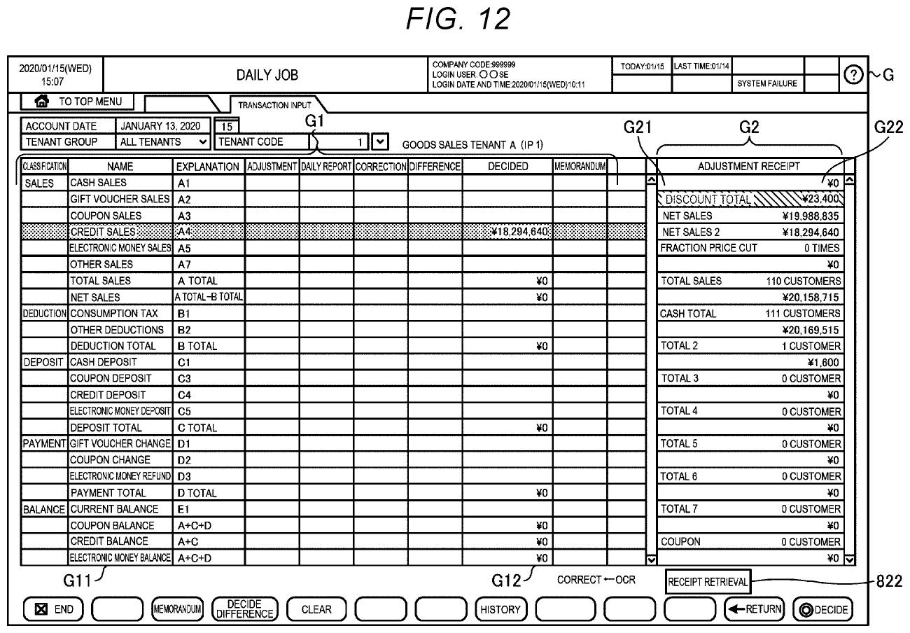

FIG. 12 depicts a display example of the daily account data and the receipt image data displayed on the display unit 81 in ACT 115 according to the present embodiment.

In the example of FIG. 12, a display G includes daily account data G1 and receipt image data G2. The daily account data G1 and the receipt image data G2 are displayed on the same screen side by side on the left and right. The daily account data G1 includes an item name section G11 where items are displayed and a sales data section G12 where sales data relating to the items are displayed. In the daily account data G1, for the items displayed in the item name section G11, sales data relating to the items are displayed in the sales data section G12 in the same rows as the items.

The receipt image data G2 includes an item name section G21 where items are displayed and a sales data section G22 where sales data relating to the items are displayed. In the receipt image data G2, for the items displayed in the item name section G21, sales data relating to the items are displayed in the sales data section G22 in the same rows as the items.

In the display G, the receipt retrieve button (or the receipt search button) 822 is displayed in a lower right position.

Referring back to FIG. 11, if the close inspection button 821 has not been operated (No in ACT 111), the control unit 700 determines whether the receipt retrieval button 822 has been operated (ACT 121).

If the receipt retrieval button 822 has been operated (Yes in ACT 121), the control unit 700 displays, a popup for inputting an item to be searched and retrieved on the display unit 81 (ACT 122).

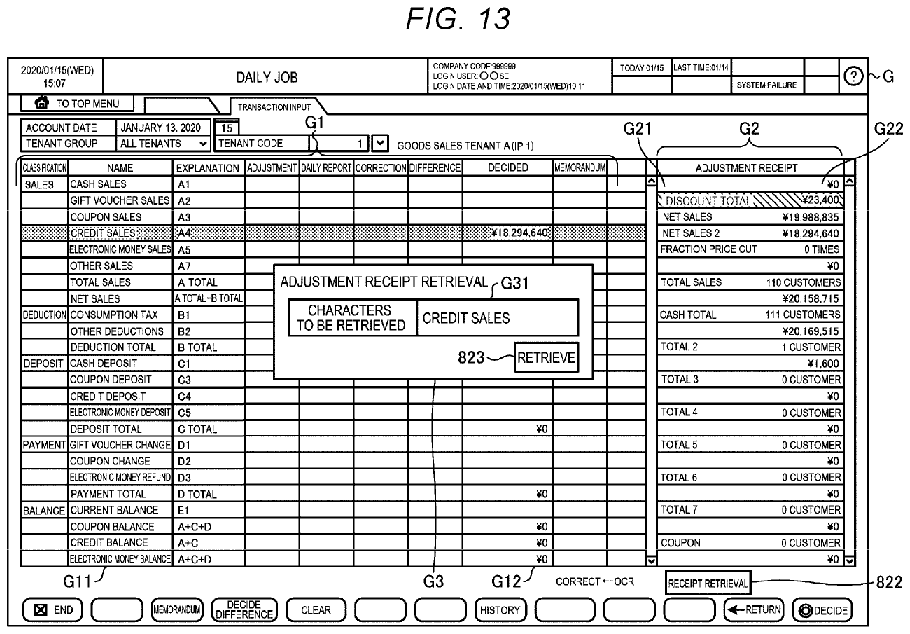

FIG. 13 depicts a display example in which a popup G3 is displayed on the display unit 81 in ACT 122 according to the present embodiment. The popup G3 is displayed over the display G. The popup G3 includes an input section G31 for inputting an item. A person in charge or an operator of the browsing terminal 7 operates the operation unit 82 and inputs, to the input section G31, an item (for example, “credit sales”) that the person in charge desires to closely inspect among the items displayed in the item name section G11.

The popup G3 includes the retrieval button (or the search button) 823. The person in charge operates the retrieval button 823 after inputting the item to the input section G31.

Referring back to FIG. 11, the control unit 700 determines whether the retrieval button 823 has been operated (ACT 123). The control unit 700 stays on standby until the retrieval button 823 is operated (No in ACT 123).

If the retrieval button 823 has been operated (Yes in ACT 123), the control unit 700 transmits the retrieval request for the input item to the server 5 (ACT 124). Subsequently, the control unit 700 determines whether the daily account data and the receipt image data responding to the retrieval request in ACT 124 has been received (ACT 125). The control unit 700 stays on standby until the daily account data and the receipt image data are received (NO in ACT 125).

If the daily account data and the receipt image data has been received, the control unit 700 stores the received daily account data and the received receipt image data in the RAM 73 (ACT 126). The control unit 700 displays the stored daily account data and the stored receipt image data on the display unit 81 side by side at a time (ACT 127). The control unit 700 returns to ACT 81.

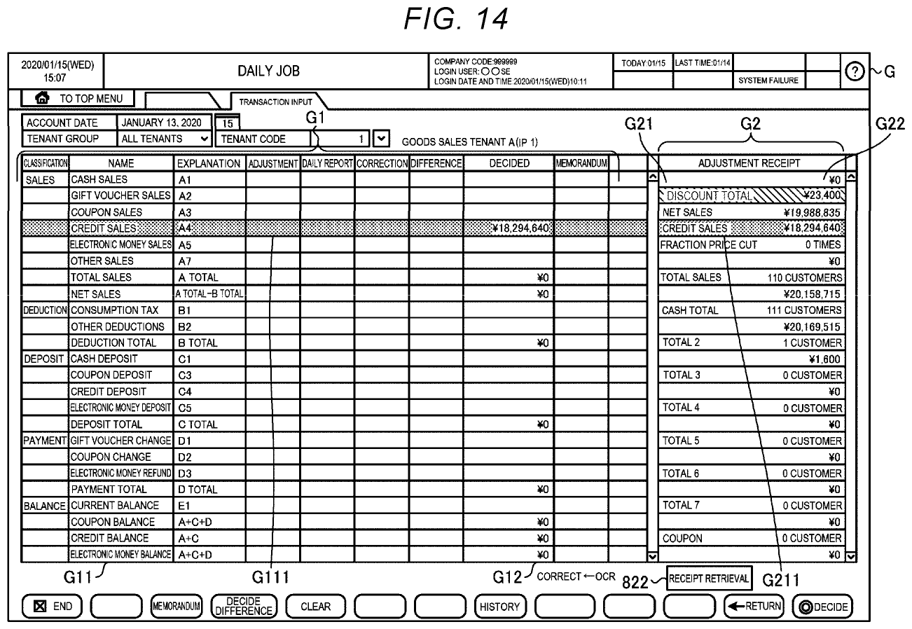

FIG. 14 depicts a display example of the daily account data and the receipt image data displayed on the display section 81 in ACT 127 according to the present embodiment. In FIG. 14, with respect to an item G111 of “credit sales” displayed in the item name section G11, both the item “credit sales” and the sales data G211 serving as the receipt image data G2 are displayed on the same screen side by side in the same row of the item name section G21 as the item G111. The item G111 and the item and the sales data G211 are displayed in the same row in a hatched state.

The server 5 (see FIG. 9) in the present embodiment includes the first acquiring unit 501 that acquires daily account data for each of items generated based on an adjustment receipt on which sales data in a predetermined period in the tenant T are printed for each of the items, the second acquiring unit 502 that acquires receipt image data obtained by imaging adjustment data for each of the items of the adjustment receipt, the display unit 503 that simultaneously displays the daily account data acquired by the first acquiring unit 501 and the receipt image data acquired by the second acquiring unit 502, and the receiving unit 504 that receives an input of item information of the daily account data. The display unit 503 of the server 5 displays sales data of the receipt image data for the received item information at a predetermined position corresponding to the sales data relating to the item of the daily account data.

Such a server 5 in the present embodiment displays an item of receipt image data relating to an item of item information, an input of which is received, and sales data relating to the item at a predetermined position corresponding to the item in daily account data. Therefore, it is possible to further compare sales data of the daily account data and sales data of the receipt image data relating to a specific item. Accordingly, it is possible to closely inspect the sales data with less labor and time.

In an embodiment, the browsing terminal 7 can be provided separately from the server 5. Daily account data and receipt image data can be received from the server 5 according to a request from the browsing terminal 7 and displayed by the browsing terminal 7. In another embodiment, the server 5 may itself incorporate and provide the functions of the browsing terminal 7. That is, the daily account data and the receipt image data may be displayed by the server 5. In other embodiments, the browsing terminal 7 may incorporate the functions of the server 5. In this case, the browsing terminal 7 would be an information processing apparatus corresponding to the server 5 of the above-described example embodiments.

In one example, the program to be executed by the server 5 may be provided by a computer-readable recording medium such as a CD-ROM, a flexible disk (FD), a CD-R, or a Digital Versatile Disc (DVD) in which the program is recorded as a file of an installable format or an executable format.

In another example, the program to be executed by the server 5 may be provided by being stored on a computer connected to a network such as the Internet and downloaded through the network. In still another example, the program to be executed by the server 5 may be accessed or distributed through the network such as the Internet.

Ina further example, the program to be executed by the server 5 may be provided by being incorporated in the ROM 52 or the like in advance.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a first acquiring unit configured to acquire totalization information from a tenant terminal, the totalization information reflecting sales data from an adjustment receipt for a tenant during a predetermined period;
a second acquiring unit configured to acquire receipt image data including the sales data from the adjustment receipt;
a display unit configured to simultaneously display the totalization information acquired by the first acquiring unit and the receipt image data acquired by the second acquiring unit; and
a receiving unit configured to receive a request for an item information in the totalization information, wherein
the display unit displays the sales data from the receipt image data for the requested item information in a position corresponding to the sales data relating to the requested item information of the totalization information.

2. The information processing apparatus according to claim 1, wherein the display unit displays the totalization information and the receipt image data on a same screen.

3. The information processing apparatus according to claim 2, further comprising:
a retrieving unit configured to retrieve the receipt image data of a first item relating to the requested item information, wherein
the display unit displays item information retrieved by the retrieving unit and the sales data relating to the requested item information at a position next to a display position of the requested item information in the totalization information.

4. The information processing apparatus according to claim 1, wherein the display unit transmits the totalization information and the receipt image data to a browsing terminal, from which a browsing request has been received, and causes the browsing terminal to display the totalization information and the sales data of the receipt image data.

5. The information processing apparatus according to claim 4, wherein the display unit causes the browsing terminal to display the totalization information and the sales data of the receipt image data side by side on a same screen of the browsing terminal.

6. The information processing apparatus according to claim 4, wherein the display unit causes the browsing terminal to display a retrieval button that can be used for requesting retrieval of the item information.

7. The information processing apparatus according to claim 1, wherein the receipt image data is image data of a printed adjustment receipt.

8. An information processing apparatus, comprising:
a memory storing a control program; and
a controller which when the control program is executed is configured to:
acquire totalization information from each of a plurality of tenants of a shopping center, the totalization information reflecting sales data from an adjustment receipt for each tenant during a predetermined period;
acquire receipt image data including the sales data from the adjustment receipt for a tenant;
receive a request for item information in the totalization information; and
display the sales data from the acquired receipt image data for the requested item information a position corresponding to the sales data relating to the requested item information in the totalization information.

9. The information processing apparatus according to claim 8, wherein the controller is further configured to:
receive a browsing request from a browsing terminal;
transmit the totalization information and the receipt image data to the browsing terminal; and
cause the browsing terminal to display the totalization information and the sales data of the receipt image data.

10. The information processing apparatus according to claim 9, wherein the controller causes the browsing terminal to display a retrieval button that is used for requesting retrieval of the item information.

11. The information processing apparatus according to claim 9, wherein the controller causes the browsing terminal to display the totalization information and the sales data of the receipt image data on a same screen simultaneously.

12. The information processing apparatus according to claim 9, wherein the controller is further configured to:
retrieve the receipt image data of a first item relating to the requested item information according to the browsing request from the browsing terminal; and
cause the browsing terminal to display the retrieved receipt image data of the first item and the sales data relating to the requested item information at a position next to a display position of the item information in the totalization information.

13. A non-transitory computer-readable medium storing a program therein that, when executed, causes a computer to perform an information processing method comprising:
acquiring totalization information from each of a plurality of tenants of a shopping center, the totalization information reflecting sales data from an adjustment receipt for each tenant during a predetermined period;
acquiring receipt image data including the sales data from the adjustment receipt for a tenant;
receiving a request for item information in the totalization information; and
displaying the sales data from the acquired receipt image data for the requested item information a position corresponding to the sales data relating to the requested item information in the totalization information.

14. The non-transitory computer-readable medium according to claim 13, the processing method further comprising:
receiving a browsing request from a browsing terminal;
transmitting the totalization information and the receipt image data to the browsing terminal; and
causing the browsing terminal to display the totalization information and the sales data of the receipt image data.

15. Thenon-transitorycomputer-readablemediumaccording to claim 14, the processing method further comprising:
causing the browsing terminal to display a retrieval button that can be used for requesting retrieval of the item information.

16. The non-transitory computer-readable medium according to claim 14, the processing method further comprising:
causing the browsing terminal to display the totalization information and the sales data of the receipt image data on a same screen simultaneously.

17. The non-transitory computer-readable medium according to claim 14, the processing method further comprising:
retrieving the receipt image data of a first item relating to the requested item information according to the browsing request from the browsing terminal; and
causing the browsing terminal to display the retrieved receipt image data of the first item and the sales data relating to the requested item information at a position next to a display position of the item information in the totalization information.

18. The non-transitory computer-readable medium according to claim 17, the processing method further comprising:
receiving a browsing request from a browsing terminal, the browsing request including the item information of the totalization information;
transmitting the totalization information and the receipt image data to the browsing terminal; and
causing the browsing terminal to display the totalization information and the sales data of the receipt image data side by side on a same screen.

19. The non-transitory computer-readable medium according to claim 13, the processing method further comprising:
receiving the totalization information from a tenant terminal, the totalization information including daily account data generated by collection of the sales data at the tenant terminal; and
receiving the receipt image data from the tenant terminal, the receipt image data corresponding to the adjustment receipt from the tenant terminal.

20. Thenon-transitorycomputer-readablemediumaccording to claim 13, wherein the receipt image data is image data of a printed adjustment receipt.
